(19) United States
(12) Patent Application Publication
(10) Pub. No.: US 2018/0238192 A1
(43) Pub. Date: Aug. 23, 2018

(54) CONNECTION BETWEEN A CIRCULAR SHELL AND A RADIAL STRUCTURAL ARM OF A TURBOMACHINE, COMPRISING A SEAL AND ITS SUPPORT

(71) Applicant: SAFRAN AIRCRAFT ENGINES, Paris (FR)

(72) Inventors: Guillaume Matthieu Jean-Louis BRUN, Chilly-Mazarin (FR); Matthieu Jean Luc Marc LOGER, Orly (FR); Guillaume PEREZ, Combs La Ville (FR); Kenny Marcel PORTE, Valpuiseaux (FR); Philippe Christophe SAVIGNAC, Wissous (FR)

(21) Appl. No.: 15/901,983

(22) Filed: Feb. 22, 2018

(30) Foreign Application Priority Data
Feb. 23, 2017 (FR) 17 51452

(51) Int. Cl. F01D 25/24; F01D 11/00

(52) U.S. Cl. CPC F01D 25/243; F05D 2240/55; F05D 2240/14; F01D 11/005

(57) ABSTRACT

A seal (13) closing off a clearance (9) between one end in the form of a bowl (7) of an arm (4) and a circular shell (1) of a turbomachine is compressed between the rim (8) of the bowl by a support (14) distinct from the platform (10) delimiting the gas flow stream (5) and retained by screws (11) already present to fix the platform to the shell (1). The layout is lighter in weight and the resistance of seal does not depend on the platform (10) exposed to damage.

This invention relates to a connection between a circular shell and a radial structural arm of a turbomachine, comprising a seal and its support

Turbomachine structures comprise hollow radial arms located between concentric shells, the ends of which consist of rims placed on the shells while leaving a connection clearance between them. A seal is often arranged at this connection to maintain leak tightness, particularly when the hollow arms can provide a pathway for oil leaks that could ignite; the seal would then prevent the fire from propagating outside the arms and spreading around the shell.

In some designs, the seal is formed along the clearance by deposition of a leak tight material that is allowed to set, but the structure assembly time is extended by the need to interrupt other work while waiting for this process to complete. Maintenance of the machine is also complicated if the seal has to be eliminated to separate the arm and disassemble it from the shell, and it also has to be removed again after every operation on the arm.

In document FR-3 010 154-A, the seal is held in place by a support that compresses it in contact with the rim of the arm. This support is a large lip contiguous with the rim that belongs to a platform concentric with the shell and the function of which is to cover the rim of the arms or the vane to shell junctions to restore a smooth circular surface suitable for a gas flow through the turbomachine. Assembly becomes faster, but the design has a disadvantage in that this support significantly increases the weight of the platform; however, there is an ongoing attempt to reduce weight in this technical field. And if the platform breaks, which is possible following the ingestion of solid bodies (hailstones or birds) into the turbomachine, the seal might be unable to retain it and it could escape, creating safety risks.

Therefore, an attempt was made to find a connection better than that described in the above document, one important purpose of which is to obtain a lighter weight support for the seal; the other disadvantages of previous designs mentioned above have also been removed.

The invention generally concerns a connection arrangement between a circular shell and a radial structural arm of a turbomachine, the arm comprising one end provided with a rim adjacent to the shell, the layout also including a platform concentric with the shell and fixed to the shell leaving (delimiting with the shell) an annular space containing the rim, and a seal present in the annular space and placed on the shell and forced into contact with the rim thus closing off a clearance between the rim and the shell, the layout being characterised in that it comprises a seal support that is distinct from the platform and is retained by attachment means that are also used to fixed the platform to the shell.

The seal support is distinct from the platform, and there is more freedom in manufacturing it and in particular it can be small and lightweight; it is not likely to disappear and allow the seal to be lost if the platform is damaged; and the use of existing attachment means to fix the platform to the shell avoids further complications to the layout.

In one form particularly conductive to a lightweight support, the support comprises a reinforcement with a shape similar to an external contour of the rim that forms a backing for the seal, and attachment cleats connected to the reinforcement, separated from each other and terminating at the said screws.

An even further optimised construction that is also easy to assemble, is characterised in that the attachment cleats are elastic and can extend along a dotted line, and said cleats are made in a single piece with the support that is metallic.

Finally, in the case of a failure of the platform, permanence of the assembly is confirmed if the layout comprises inserts around the attachment means, onto which the platform is click fitted, the support is compressed between the platform and the inserts, and the inserts are compressed between the support and the heads of the attachment means.

The different aspects, characteristics and advantages of the invention will now be described in more detail with reference to the following figures, that represent one detailed embodiment that is not exclusive of others:

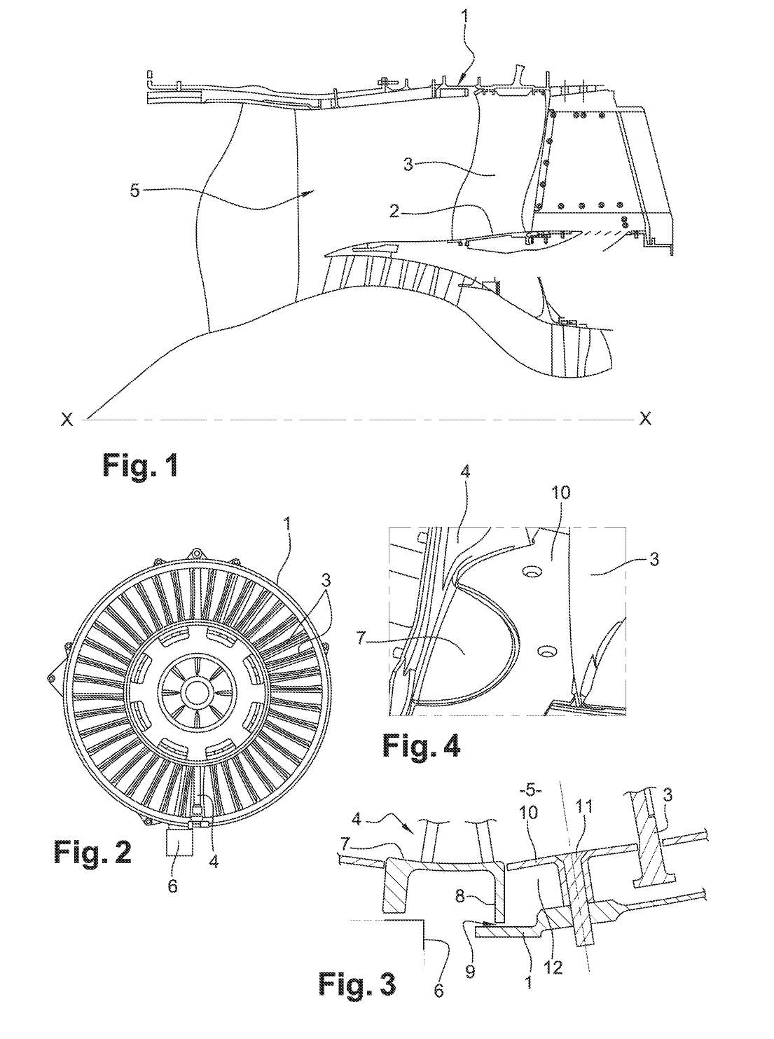

FIG. 1 is an axial sectional view showing part of a turbomachine and the possible location of the invention;

FIG. 2 is a cross-section through the turbomachine;

FIG. 3 is a cross-section showing the connection layout without the seal, between the arm and the shell;

FIG. 4 is a perspective view of this layout, seen from the flowstream;

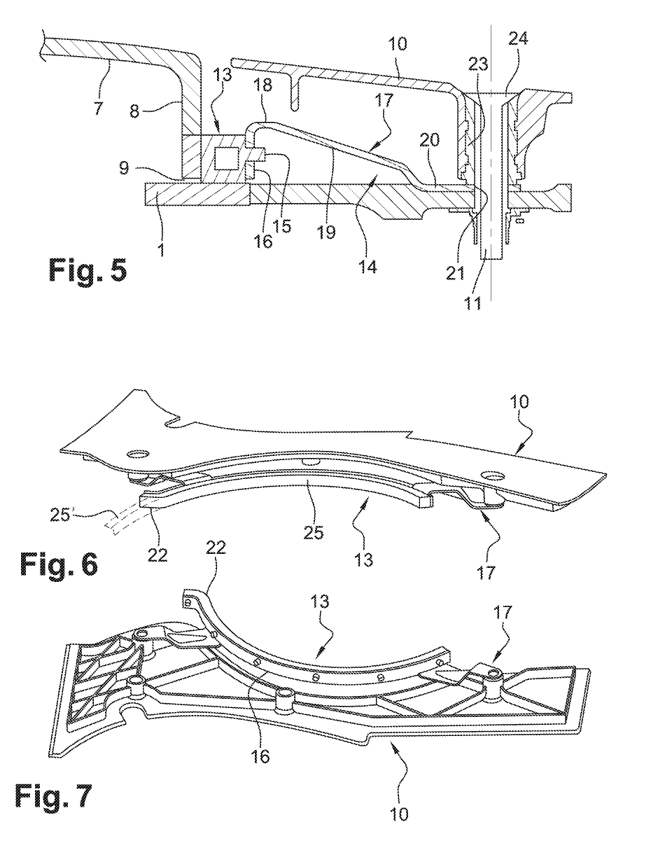

FIG. 5 is a cross-section showing the layout according to the invention;

and FIGS. 6 and 7 are perspectives views showing the seal and its support along two opposite directions.

FIG. 1 shows a region of a turbomachine on which the invention can be used, between an intermediate case shell (ICS), hereinafter simply called the shell 1, that surrounds a hub 2. Fixed vanes 3 (“outlet guide vanes” or OGV) and arms 4 along the radial direction in the turbomachine connect the shell 1 to the hub 2. In this case, the fixed vanes 3 lie in a bypass flow stream 5 of a twin spool engine, although this is not compulsory for the invention.

The embodiment described comprises two opposite arms 4, represented in FIG. 2, one of which is at the 6 o'clock angular position and terminates in front of a transfer gearbox (TGB) 6. The arm 4 is hollow and open, and a radial shaft (not shown) can pass through it to start the turbomachine by transmitting energy from an electric motor to its rotor through the gearbox 6 and other transmissions. However, oil can escape from the gearbox 6 and spread into the arm 4, with fire risks that justify confinement of the internal volume of the arm 4.

The layout of the connection of the arm 4 to the shell 1 is shown on FIGS. 3 and 4. The end of the arm 4 is shaped as an enlargement called a bowl 7 and that includes a cylindrical rim 8 that extends in the direction radial to the X-X axis of the turbomachine, the end of which is separated from the shell 1 by a clearance 9 in which the seal must be maintained. A platform 10 concentric with the shell 1 is assembled to the shell by attachment means such as screws 11, delimiting with the shell an annular or essentially annular space 12 in which the bowl of each arm 4 and the ends of the fixed vanes 3 are contained, and thus to limit the flow stream 5 by a regular and continuous surface. In reality, the platform 10 is composed of distinct elements assembled individually to the shell 1 and each extending on an angular sector of the machine between two adjacent fixed vanes 3, or one of the arms 4 and one of the fixed vanes 3 adjacent to it. Only one of these elements is shown completely herein, but they are in physical contact once assembled and therefore the platform 10 is continuous. It is circular or essentially circular, its elements possibly being curved or plane.

The layout is completed by a seal 13 and its support 14, as shown on FIGS. 5 and 6. The seal 13 is deformable and elastic, it is placed on the shell 1 and compressed in contact with the rim 8 to close off the clearance 9. The support 14 acts as backing for its opposite face on which pins 15 are formed to retain it. The shape of the support 14 can be circular, in a single piece, and it comprises a reinforcement 16, with a shape similar to an external contour of the rim 8, and therefore in this case is a plate curved along the arc of a circle concentric with the rim 8, and attachment cleats 17 made as a single piece from the same material, starting from the external edge of the reinforcing 16 along divergent directions and extending to some of the attachment screws 11 of the platform 10. The reinforcement 16 is at a uniform distance from the rim 8 and is drilled at a constant pitch to contain the pins 15. The attachment cleats 17 are composed of successive portions forming a dotted line, namely a portion 18 connected to an inner edge (at a distance from the shell 1) of the reinforcement 16 and with no radial inclination, an intermediate portion 19 with a radial inclination and an end 20 with no radial inclination, placed on the shell 1 and provided with a drilling 21 through which the screw 11 passes. The support 14 is advantageously metallic, for example made of titanium, the attachment cleats have high elasticity and a capacity for deformation that facilitates their assembly while maintaining a well-defined compression of the seal 13 between the reinforcement 16 and the rim 8.

FIGS. 6 and 7 show that the seal 13 and the support 14 are usually composed of successive sectors of a circle to facilitate assembly around the rim 8. The sectors 25 of the seal 13 can be provided with overlap portions 22 curved outwards from the reinforcement 16 relative to the main part of the sector and that bear on a complementary end of an adjacent sector (25′ on FIG. 6) so as to assure good continuity of the seal 13. Several attachment cleats 17 will generally be provided for better attachment of the seal 13, for example twice two if the seal 13 and the support 14 are composed of two semicircular portions, as in this case.

The platform 10 is indirectly retained by screws 11, being click fitted around metallic inserts 23 threaded around each screw 11, and that the heads 24 of screws 11 push towards the shell 1 by compressing the attachment cleats 17 around the drillings 21. This layout maintains the attachment of the support 14 and the seal 13 by screws 11 and inserts 23 even if the platform 10, exposed to damage and frequently made of a weaker material (for example polymer) than the screws 11 and inserts 23, disappears at this location.

1. Connection layout between a circular shell (1) and a radial structural arm (4) of a turbomachine, the arm comprising one end (7) fitted with a rim (8) adjacent to the shell (1) and with a radial extension in the turbomachine, the layout also comprising a platform (10) concentric with the shell and fixed to the shell, delimiting with the shell an annular space (12) containing the rim (8), and a seal (13) present in the annular space, placed on the shell and held in contact with the rim and thus closing off a clearance (9) between the rim and the shell, the layout being characterised in that it comprises a support (14) for the seal (13) that is distinct from the platform (10) and is retained by attachment means (11) that fix the platform to the shell (1).

2. Connection layout between a circular shell and a radial structural arm of a turbomachine according to claim 1, characterised in that the support (14) comprises a reinforcement (16) with a shape similar to an external contour of the rim that forms a backing for the seal (13), and attachment cleats (17) connected to the reinforcement, separated from each other and terminating at said attachment means (11).

3. Connection layout between a circular shell and a radial structural arm of a turbomachine according to claim 2, characterised in that the attachment cleats are elastic and can extend along a dotted line, and said cleats are made in a single piece with the support that is metallic.

4. Connection layout between a circular shell and a radial structural arm of a turbomachine according to claim 1, characterised in that it comprises inserts (23) around the attachment means (11), onto which the platform (10) is click fitted, the support (14) is compressed between the platform and the inserts, and the inserts are compressed between the support and the heads (24) of the attachment means.

5. Connection layout between a circular shell and a radial structural arm of a turbomachine according to claim 1, characterised in that the attachment means (11) are screws.

6. Connection layout between a circular shell and a radial structural arm of a turbomachine according to claim 2, characterised in that the shape of the reinforcement follows an arc of a circle concentric with an external contour of the circular shaped rim.

7. Connection layout between a circular shell and a radial structural arm of a turbomachine according to claim 1, characterised in that seal (13) and the support are composed of successive sectors, the sectors of the seal comprising an overlap portion (22) at one end, curved relative to a principal part of the sector and bearing on an adjacent sector of the seal.
